(19) United States
(12) Patent Application Publication
(10) Pub. No.: US 2016/0149852 A1
(43) Pub. Date: May 26, 2016

(54) GROUP FORMATION FOR EMPLOYEE ACTIVATION

(71) Applicant: Linkedln Corporation, Mountain View, CA (US)

(72) Inventors: Wayne Pan, San Jose, CA (US); Nicholas David Snyder, Belmont, CA (US); William Jayang Sun, San Francisco, CA (US)

(21) Appl. No.: 14/880,992

(22) Filed: Oct. 12, 2015

Related U.S. Application Data
(60) Provisional application No. 62/110,406, filed on Jan. 30, 2015.
(60) Provisional application No. 62/083,847, filed on Nov. 24, 2014.

(51) Int. Cl. H04L 12/58; H04L 29/08

(52) U.S. Cl. CPC H04L 51/32; H04L 51/24; H04L 67/306

(57) ABSTRACT

Techniques for forming groups of employees for receiving online content broadcasted by company administrators via an online social networking service are described. According to various embodiments, a plurality of content items is displayed, via an administrator user interface, to a user associated with a company. Thereafter, a user specification of a topic-based group is received together with a user request to broadcast a recommendation to view a specific content item to one or more employees of the company that are members of an online social networking service and that are associated with the topic-based group. The employees of the company that are associated with the topic-based group are then identified, and the recommendation to view the specific content item is broadcasted to the employees of the company that are associated with the topic-based group.

### RELATED APPLICATIONS

This application claims the benefit of priority of U.S. Provisional Patent Application Ser. No. 62/110,406, filed Jan. 30, 2015, and U.S. Provisional Patent Application Ser. No. 62/083,847, filed Nov. 24, 2014, which applications are incorporated herein by reference in their entirety.

### TECHNICAL FIELD

The present application relates generally to data processing systems and, in one specific example, to techniques for forming groups of employees for receiving online content broadcasted by company administrators via an online social networking service.

### BACKGROUND

Online social networking services such as LinkedIn® are becoming increasingly popular, with many such websites boasting millions of active members. Each member of the online social networking service is able to upload an editable member profile page to the online social networking service. The member profile page may include various information about the member.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 is a flowchart illustrating an example method, according to various embodiments;

FIG. 4 illustrates example portions of user interfaces, according to various embodiments;

FIG. 5 is a flowchart illustrating an example method, according to various embodiments;

FIG. 6 illustrates an example portion of a user interface, according to various embodiments;

FIG. 7 illustrates an example portion of a user interface, according to various embodiments;

FIG. 8 is a flowchart illustrating an example method, according to various embodiments;

FIG. 9 is a flowchart illustrating an example method, according to various embodiments;

FIG. 10 illustrates an example portion of a user interface, according to various embodiments;

FIG. 11 illustrates an example portion of a user interface, according to various embodiments;

FIG. 12 is a flowchart illustrating an example method, according to various embodiments;

FIG. 13 illustrates an example mobile device, according to various embodiments; and

FIG. 14 is a diagrammatic representation of a machine in the example form of a computer system within which a set of instructions, for causing the machine to perform any one or more of the methodologies discussed herein, may be executed.

### DETAILED DESCRIPTION

Example methods and systems for forming groups of employees for receiving online content broadcasted by company administrators via an online social networking service are described. In the following description, for purposes of explanation, numerous specific details are set forth in order to provide a thorough understanding of example embodiments. It will be evident, however, to one skilled in the art that the embodiments of the present disclosure may be practiced without these specific details.

According to various example embodiments, an employee activation system enables company administrators to leverage their employee's social networks in order to expand the reach of the company through various online social networking services. For example, in some embodiments, the employee activation system displays an administrator user interface to an administrator or other personnel associated with a company. The administrator user interface may display various suggested content items, such as news items, articles, publications, etc., such as via a content feed. The employee activation system enables the company administrator to select a specific content item to be broadcast to employees of the company. The system will then broadcast a recommendation to view the selected content item to one or more of the employees of the company.

Thereafter, the relevant employees may receive the broadcasted recommendations to view the specific content item, such as via a mobile application on their mobile device that is associated with the online social networking service. The employee can then browse through the suggested content and share a piece of content among their various networks of connections on various online social networking services, such as Facebook®, Twitter®, Instagram®, LinkedIn® etc. Accordingly, the employee activation system enables a company administrator to broadcast a piece of content to the employees of the company, and then enables the employees of that company to share that content among their networks on various online social networking services.

Thus, by delivering highly-relevant professional content and encouraging content sharing, the employee activation system enables employees to be more productive and successful, by helping them to reach audiences related to their day-to-day work and build their professional brand. Meanwhile, companies are motivated to assist and elevate their employees, and the employee activation system provides companies with the insights necessary to ensure relevant content for their employees. Thus, the employee activation system harnesses company motivation and insight, and the hypothesis that colleagues have a good sense of what content is professionally relevant to others in that company, in order to deliver the right content to the right professionals, and to activate employees on social networks. Accordingly, by improving the relevance of content shared with employees and other users, the system described herein efficiently provides users with more relevant content sooner, which reduces the need for further searching and browsing for content on the part of users. This may result in a reduction in the processing power and network bandwidth demands placed on an online social networking service's hardware and software infrastructure.

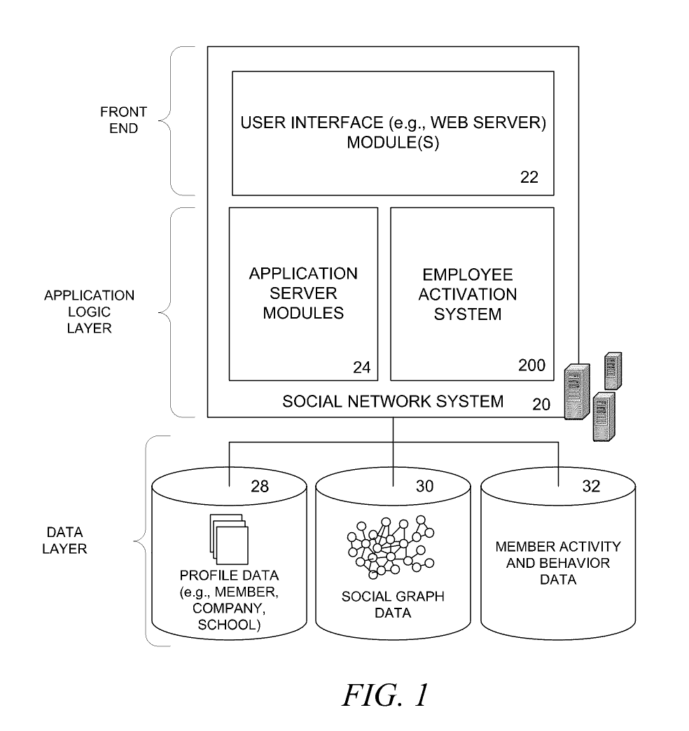

FIG. 1 is a block diagram illustrating various components or functional modules of a social networking service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social networking service. For instance, the ability of an organization to establish a presence in the social graph of the social networking service, including the ability to establish a customized web page on behalf of an organization, and to publish messages or status updates on behalf of an organization, may be services implemented in independent application server modules 24. Similarly, a variety of other applications or services that are made available to members of the social networking service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social networking service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social networking service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social networking service may provide a broad range of other applications and services that allow members the opportunity to share and receive information, often customized to the interests of the member. For example, with some embodiments, the social networking service may include a photo sharing application that allows members to upload and share photos with other members. With some embodiments, members may be able to self-organize into groups, or interest groups, organized around a subject matter or topic of interest. With some embodiments, the social networking service may host various job listings providing details of job openings with various organizations.

As members interact with the various applications, services and content made available via the social networking service, the members' behavior (e.g., content viewed, links or member-interest buttons selected, etc.) may be monitored and information concerning the member's activities and behavior may be stored, for example, as indicated in FIG. 1 by the database with reference number 32.

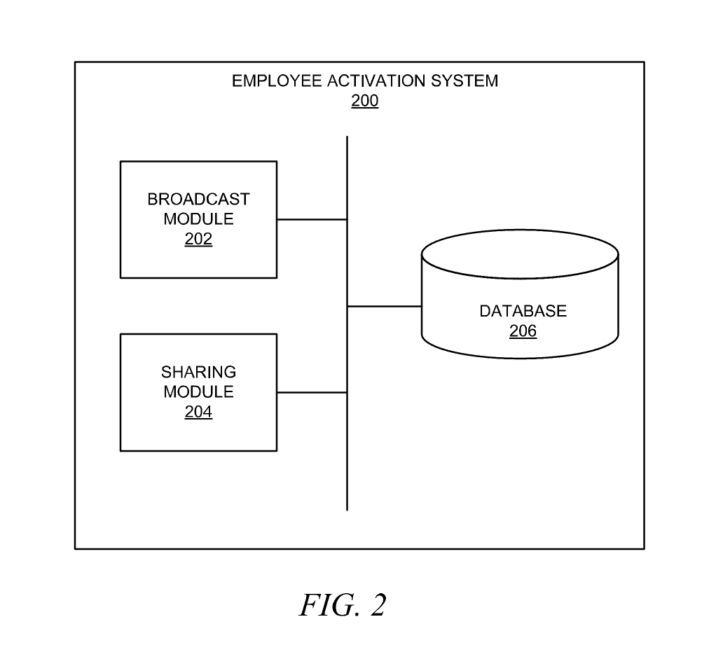

With some embodiments, the social network system 20 includes what is generally referred to herein as an employee activation system 200. The employee activation system 200 is described in more detail below in conjunction with FIG. 2.

Although not shown, with some embodiments, the social network system 20 provides an application programming interface (API) module via which third-party applications can access various services and data provided by the social networking service. For example, using an API, a third-party application may provide a user interface and logic that enables an authorized representative of an organization to publish messages from a third-party application to a content hosting platform of the social networking service that facilitates presentation of activity or content streams maintained and presented by the social networking service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, an employee activation system 200 includes a broadcast module 202, a sharing module 204, and a database 206. The modules of the employee activation system 200 may be implemented on or executed by a single device such as an employee activation device, or on separate devices interconnected via a network. The aforementioned employee activation device may be, for example, one or more client machines or application servers. The operation of each of the aforementioned modules of the employee activation system 200 will now be described in greater detail in conjunction with the various figures.

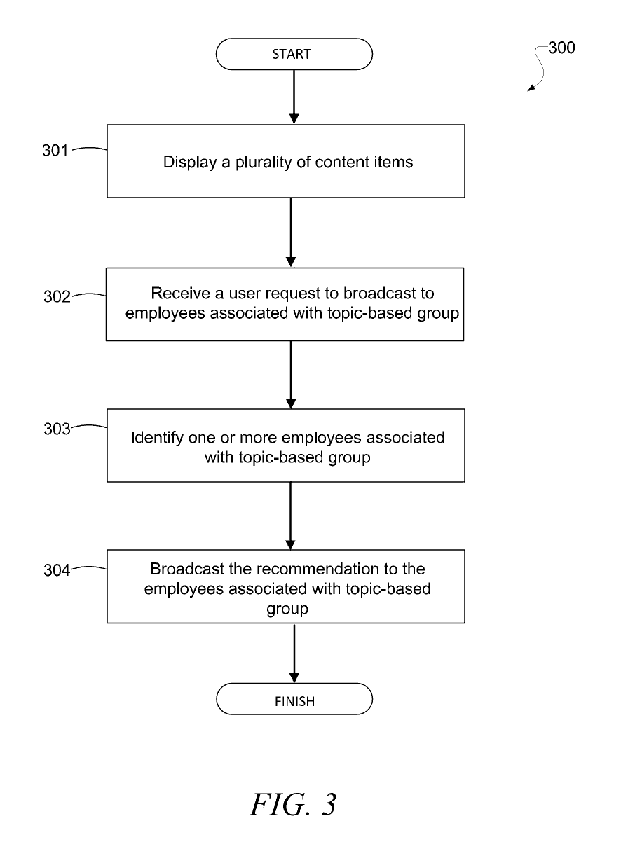

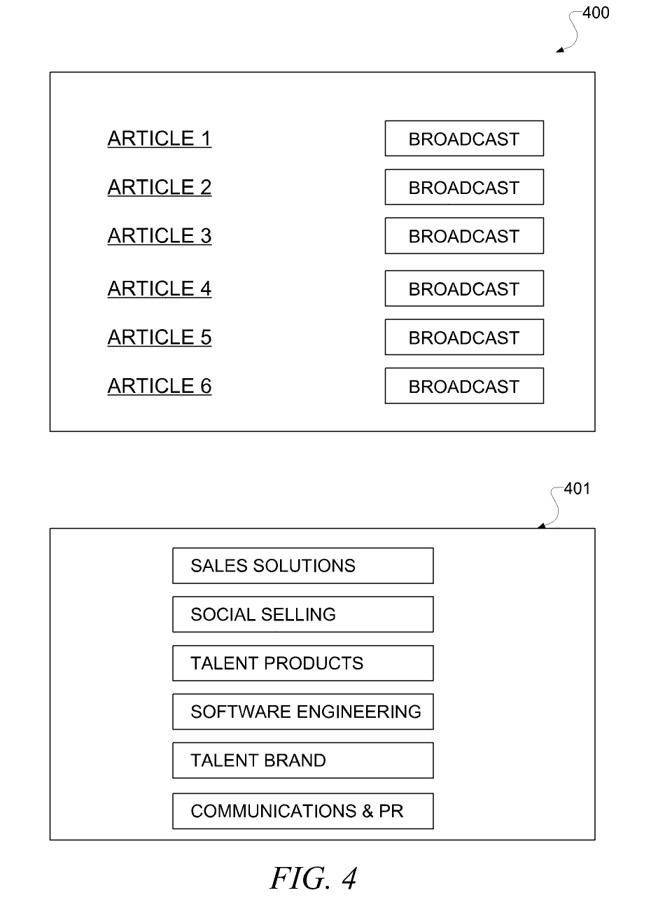

FIG. 3 is a flowchart illustrating an example method 300, consistent with various embodiments described herein. The method 300 may be performed at least in part by, for example, the employee activation system 200 illustrated in FIG. 2 (or an apparatus having similar modules, such as one or more client machines or application servers). In operation 301, the broadcast module 202 displays, via an administrator user interface, to a user (e.g., an administrator) associated with a company, a plurality of suggested content items. In some embodiments, the suggested content items are displayed in a content feed in the administrator user interface (e.g., see user interface 400 in FIG. 4).

In operation 302, the broadcast module 202 receives, via the administrator user interface, a user specification of a topic-based group, and a user request to broadcast a recommendation of a specific one of the content items (that was displayed in operation 301) to one or more employees of the company that are members of an online social networking service and that are associated with (e.g., that have subscribed to) the selected topic-based group. In some embodiments, each of the topic-based groups is associated with a particular genre or topic, and indicates that members of the group are interested in that particular genre or topic. For example, the administrator may select the “BROADCAST” button associated with one of the articles in the content feed displayed in user interface 400 in FIG. 4. The broadcast module 202 may then display, via the administrator user interface, indicia of multiple topic-based groups of employees, and the broadcast module 202 may receive, via the administrator user interface, a user selection of one of the indicia associated with one of the topic-based group of employees (see user interface 401 in FIG. 4).

In operation 303, the broadcast module 202 identifies one or more employees of the company that are members of the online social networking service and that are associated with the topic-based group. For example, the broadcast module 202 may then identify which of the company's employees are listed in a company-specific group membership list associated with a topic-based group, where such company-specific group membership lists may be stored in the database 206. Techniques by which company employees are associated with a particular topic-based group are described in more detail below.

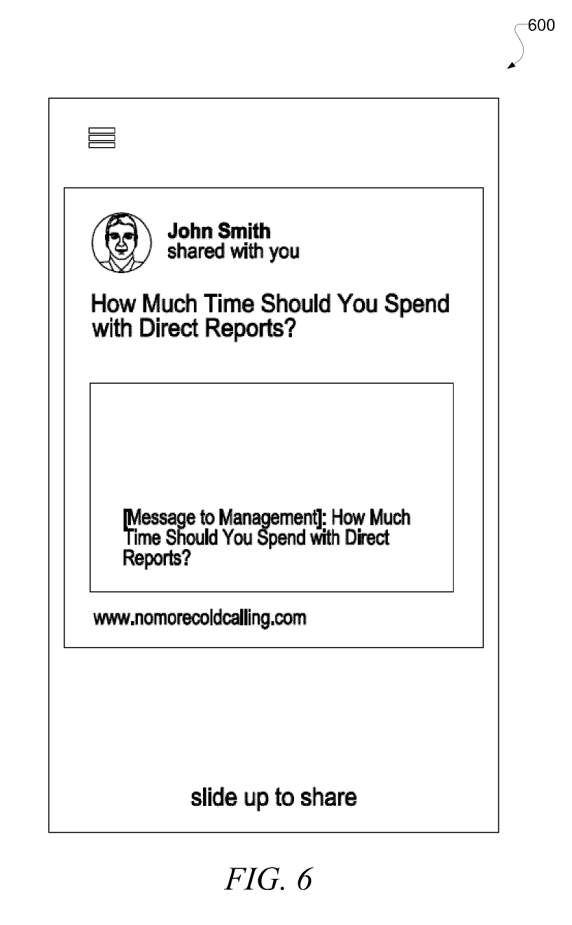

In operation 304, the broadcast module 202 broadcasts the recommendation to view the specific content item to the employees of the company that are associated with the topic-based group (as identified in operation 303). In some embodiments, the broadcasting comprises displaying the recommendation to view the specific content item via an employee user interface displayed on one or more mobile devices associated with the employees (e.g., see FIG. 6).

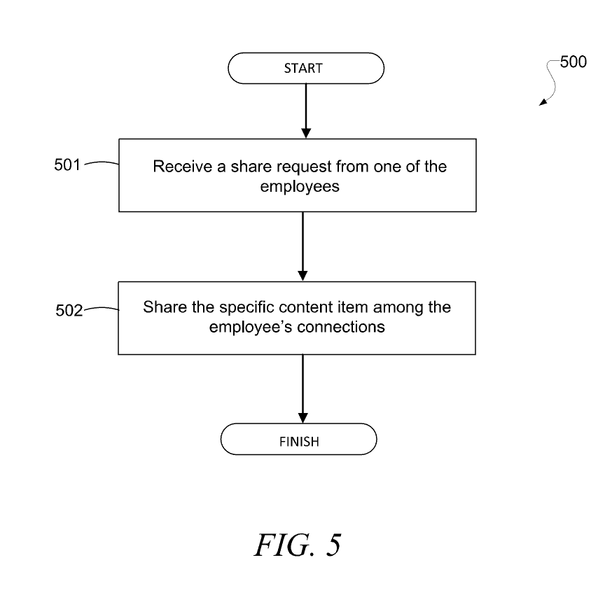

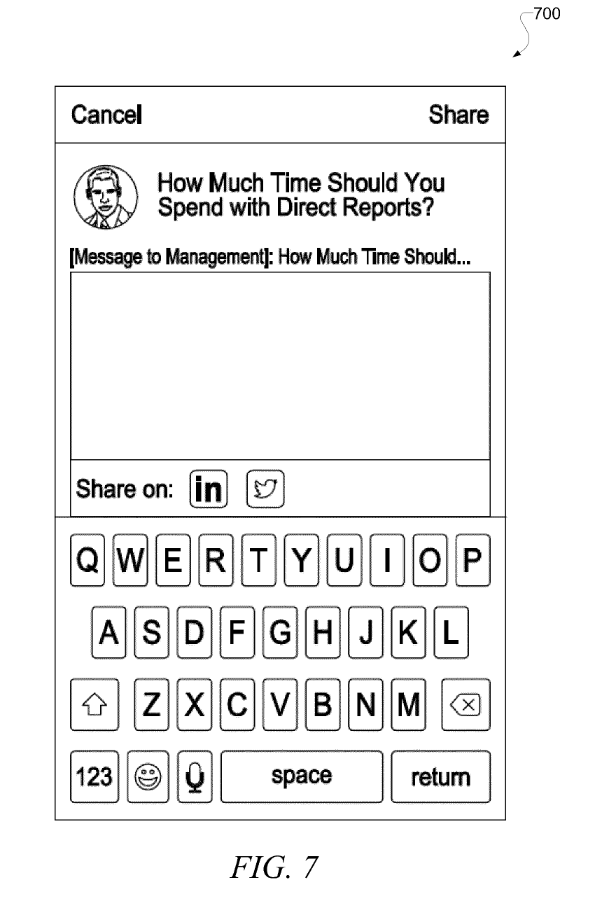

FIG. 5 is a flowchart illustrating an example method 500 of employee sharing of a content item, consistent with various embodiments described herein. The method 500 may be performed at least in part by, for example, the employee activation system 200 illustrated in FIG. 2 (or an apparatus having similar modules, such as one or more client machines or application servers). In operation 501, the sharing module 204 receives, via an employee user interface, a share request from one of the employees of a company that received a broadcast of a specific content item (e.g., see operation 304 in FIG. 3). The share request is a request to share the specific content item among the employee's connections on a specific online social networking service. FIG. 6 illustrates an example of an employee user interface 600 displayed via a mobile application installed on a mobile device of an employee. The employee user interface 600 displays a content item entitled “Message to management; how much time should you spend with the direct reports?” shared by a company administrator “John Smith”. The employee may select to this article for sharing (e.g., by sliding up on the user interface 600), and the sharing module 204 may display the user interface 700 illustrated in FIG. 7, which enables the employee to prepare and send a share message (e.g., by displaying keypad allowing the employee to modify the title of the share message). In particular, the sharing module 204 may display, via the employee user interface 700, indicia of multiple online social networking services (e.g., the LinkedIn® symbol and the Twitter® symbol as illustrated in FIG. 7), and the sharing module 204 may receive, via the employee user interface, a user selection of one of the indicia associated with a specific online social networking service. Referring back to FIG. 5, in operation 502, the sharing module 204 shares the specific content item among the employee's connections on the specific online social networking service that was specified in operation 501. For example, the 502 may cause the content item to appear in a content feed or stream of the selected online social networking service that is viewable to the employee's connections on that selected online social networking service. It is contemplated that the operations of method 500 may incorporate any of the other features disclosed herein. Various operations in the method 500 may be omitted or rearranged, as necessary.

The various employee user interfaces described herein (e.g., see FIGS. 6 and 7) may displayed on a desktop, tablet, mobile device (e.g., via a mobile application), or within any type of electronic message, including an e-mail, text message (e.g., a short messaging service (SMS) message, a multimedia messaging service (MMS) message, etc.), an instant message associated with an online social network (e.g., Facebook®, LinkedIn®, Wechat®, WhatsApp®, etc.), a chat message associated with an online chat service, and so on.

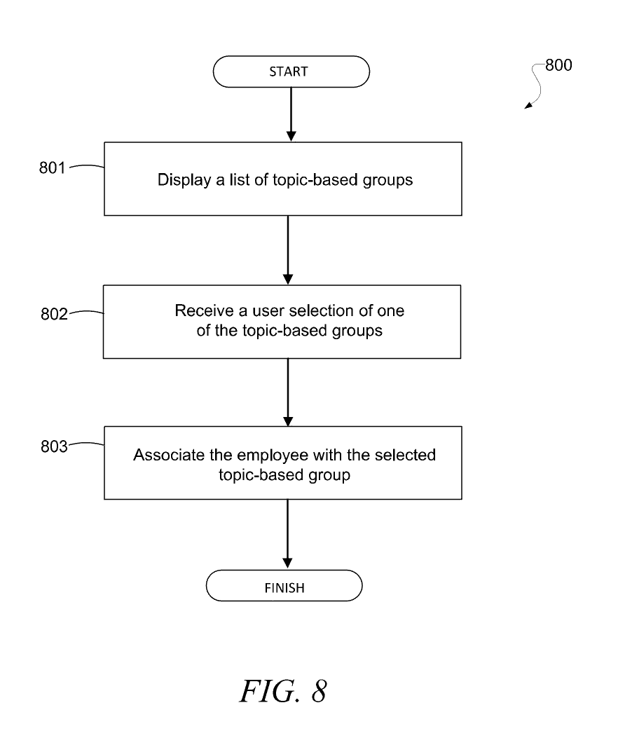

FIG. 8 is a flowchart illustrating an example method 800 of associating employees of a company with topic-based groups, consistent with various embodiments described herein. The method 800 may be performed at least in part by, for example, the employee activation system 200 illustrated in FIG. 2 (or an apparatus having similar modules, such as one or more client machines or application servers). In operation 801, the broadcast module 202 displays, via an employee user interface displayed on a mobile device associated with an employee, a list of topic-based groups (e.g., similar to 401 in FIG. 4). In operation 802, the broadcast module 202 receives, via the employee user interface, a user selection of one of the topic-based groups displayed in operation 801. In operation 803, the broadcast module 202 associates the employee with the topic-based group selected in operation 802. For example, the broadcast module 202 may include the employee in a company-specific group membership list associated with a topic-based group, where such a company-specific group membership list identifies employees of a company that are associated with (or that have subscribed to) a particular topic-based group. Such a company-specific group membership list may be stored in the database 206. It is contemplated that the operations of method 800 may incorporate any of the other features disclosed herein. Various operations in the method 800 may be omitted or rearranged, as necessary.

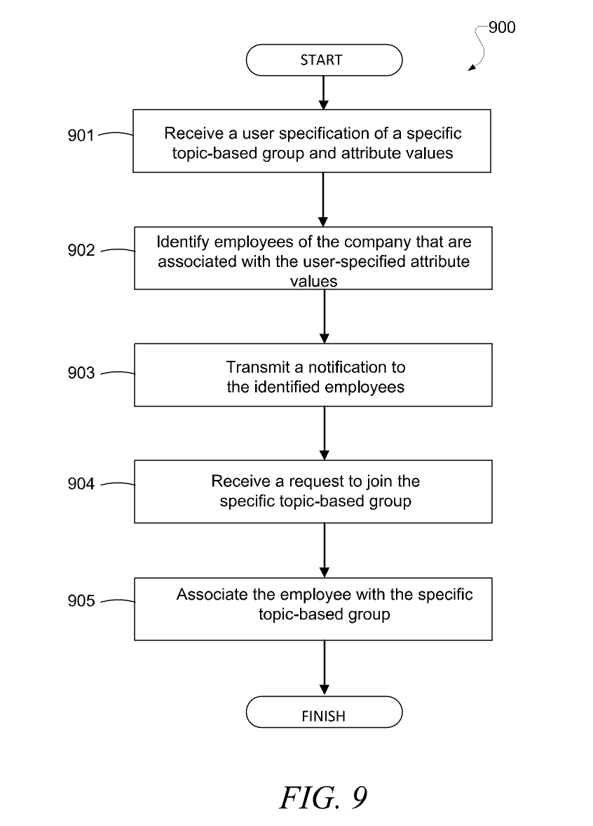

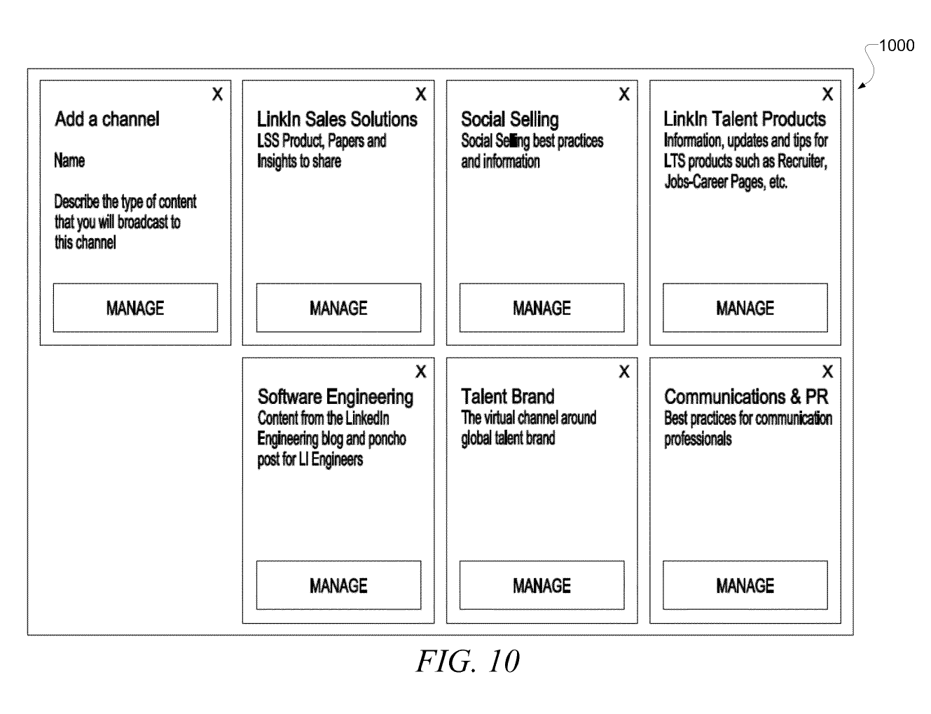

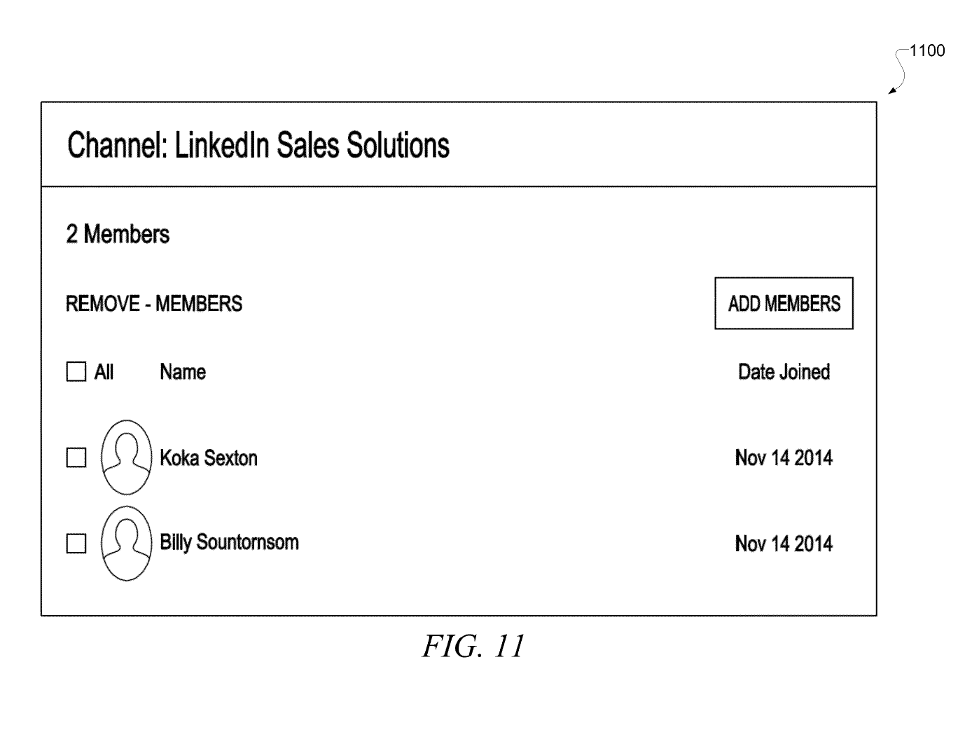

FIG. 9 is a flowchart illustrating an example method 900 of associating employees of a company with topic-based groups, consistent with various embodiments described herein. The method 900 may be performed at least in part by, for example, the employee activation system 200 illustrated in FIG. 2 (or an apparatus having similar modules, such as one or more client machines or application servers). In operation 901, the broadcast module 202 receives, via an administrator user interface, a user specification of a specific topic-based group and attribute values for one or more member profile attributes. For example, the administrator may click on the “MANAGE” button associated with one of the groups in the UI 1000 in FIG. 10. The UI 1100 in FIG. 11 indicating current employee members of this group may then be displayed, and the administrator can click on the “ADD MEMBERS” button. Another user interface may then be displayed allowing the administrator to selects attribute values for member profile attributes such as job title, company, age, location, industry, current job, employer, experience, skills, education, school, groups, company, Influencers followed, endorsements, seniority level, company size, connection count, connection identities, and so on. In operation 902, the broadcast module 202 identifies employees of the company on the online social networking service that are associated with the attribute values specified in operation 901 (e.g., based on member profile data associated with each of the employees that is maintained by the online social networking service). In operation 903, the broadcast module 202 transmits a notification to the employees identified in operation 902 prompting them to join the specific topic-based group. In operation 904, the broadcast module 202 receives, via an employee user interface displayed on a device associated with a specific one of the employees identified in operation 903, a request to join the specific topic-based group. In operation 905, the broadcast module 202 associates the specific employee with the specific topic-based group. For example, the broadcast module 202 may include the specific employee in a company-specific group membership list associated with a topic-based group, where such a company-specific group membership list identifies employees of a company that are associated with (or that have subscribed to) a particular topic-based group. Such a company-specific group membership list may be stored in the database 206. It is contemplated that the operations of method 900 may incorporate any of the other features disclosed herein. Various operations in the method 900 may be omitted or rearranged, as necessary.

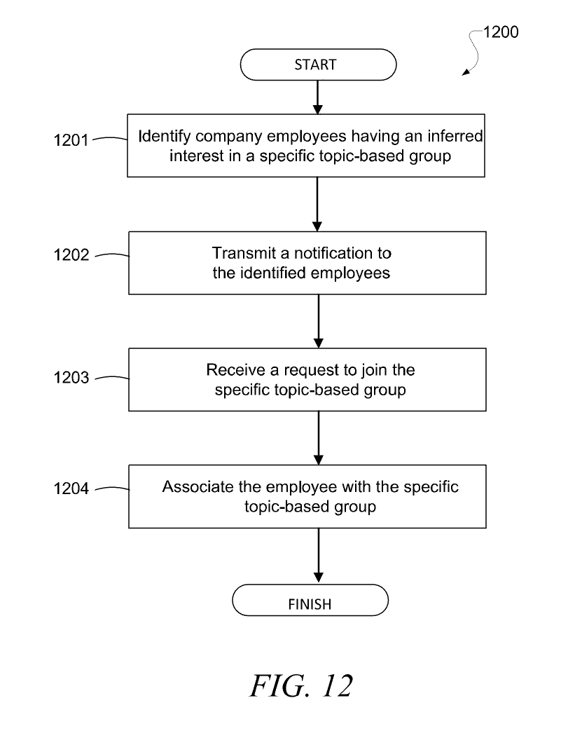

FIG. 12 is a flowchart illustrating an example method 1200 of associating employees of a company with topic-based groups, consistent with various embodiments described herein. The method 1200 may be performed at least in part by, for example, the employee activation system 200 illustrated in FIG. 2 (or an apparatus having similar modules, such as one or more client machines or application servers). In operation 1201, the broadcast module 202 identifies employees of a company that are members of an online social networking service and that have an inferred interest in a specific topic-based group, based on member profile attributes of the employees. For example, the broadcast module may identify a correspondence (e.g., a similarity or an exact match) between the title of the topic-based group (or keywords in online content shared via webpages, emails, or mobile applications associated with the topic-based group) and member profile attributes of members. The member profile attributes include job title, age, location, industry, current job, employer, experience, skills, education, school, groups, company, Influencers followed, endorsements, seniority level, company size, connection count, connection identities, and so on. In operation 1202, the broadcast module 202 transmits a notification to the employees identified in operation 1201 prompting them to join a specific topic-based group. In operation 1203, the broadcast module 202 receives, via an employee user interface displayed on a device associated with a specific one of the employees identified in operation 1202, a request to join the specific topic-based group. In operation 1204, the broadcast module 202 associates the specific one of the identified employees with the specific topic-based group. For example, the broadcast module 202 may include the specific employee in a company-specific group membership list associated with a topic-based group, where such a company-specific group membership list identifies employees of a company that are associated with (or that have subscribed to) a particular topic-based group. Such a company-specific group membership list may be stored in the database 206. It is contemplated that the operations of method 1200 may incorporate any of the other features disclosed herein. Various operations in the method 1200 may be omitted or rearranged, as necessary.

In some embodiments, by analyzing content that members have previously read and shared on LinkedIn already, the system 200 can compare how similar that content is to the content that is being broadcasted to specific topics using standard natural language processing similarity comparisons (e.g. topic modeling). If there is a high degree of overlap, then the system 200 can infer that a member should subscribe to this topic. For example, if a user is reading and sharing lots of product management content on LinkedIn today, and the system 200 determines that there exists a topic called “Entrepreneurship” which happens to also contain similar product management content, the system 200 could recommend that the user subscribe to the topic “Entrepreneurship”.

In some embodiments, by looking at members who are already subscribed to specific topics, and comparing how similar additional members are to these subscribers through similarity algorithms derived from profile attributes, the system 200 can infer that they should also join the topic. For example, if a user is a product manager (as specified by their member profile attributes), the system 200 may find that many other product managers, designers, and managers are subscribed to “Entrepreneurship” and since these profiles have similar attributes with the user, the system 200 may recommend that the user subscribe to “Entrepreneurship”

### Example Mobile Device

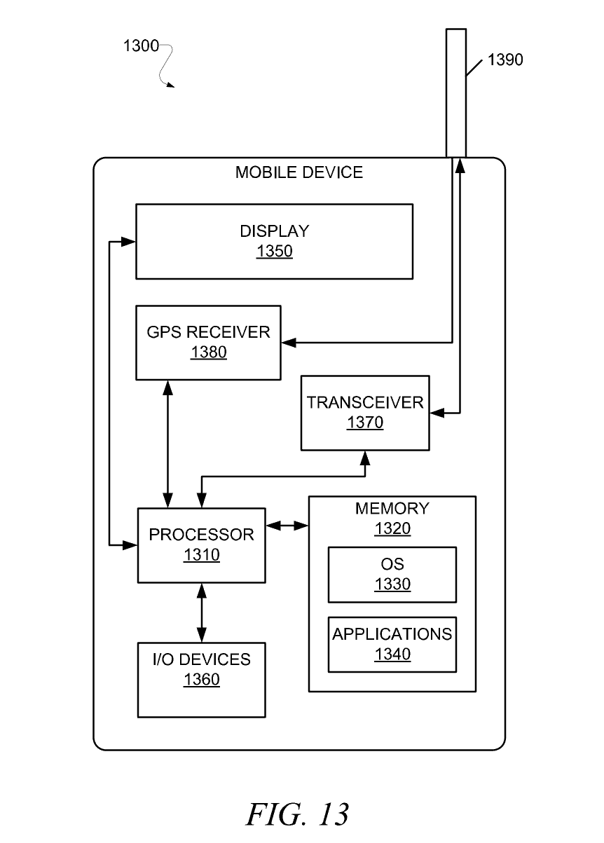

FIG. 13 is a block diagram illustrating the mobile device 1300, according to an example embodiment. The mobile device may correspond to, for example, one or more client machines or application servers. One or more of the modules of the system 200 illustrated in FIG. 2 may be implemented on or executed by the mobile device 1300. The mobile device 1300 may include a processor 1310. The processor 1310 may be any of a variety of different types of commercially available processors suitable for mobile devices (for example, an XScale architecture microprocessor, a Microprocessor without Interlocked Pipeline Stages (MIPS) architecture processor, or another type of processor). A memory 1320, such as a Random Access Memory (RAM), a Flash memory, or other type of memory, is typically accessible to the processor 1310. The memory 1320 may be adapted to store an operating system (OS) 1330, as well as application programs 1340, such as a mobile location enabled application that may provide location based services to a user. The processor 1310 may be coupled, either directly or via appropriate intermediary hardware, to a display 1350 and to one or more input/output (I/O) devices 1360, such as a keypad, a touch panel sensor, a microphone, and the like. Similarly, in some embodiments, the processor 1310 may be coupled to a transceiver 1370 that interfaces with an antenna 1390. The transceiver 1370 may be configured to both transmit and receive cellular network signals, wireless data signals, or other types of signals via the antenna 1390, depending on the nature of the mobile device 1300. Further, in some configurations, a GPS receiver 1380 may also make use of the antenna 1390 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

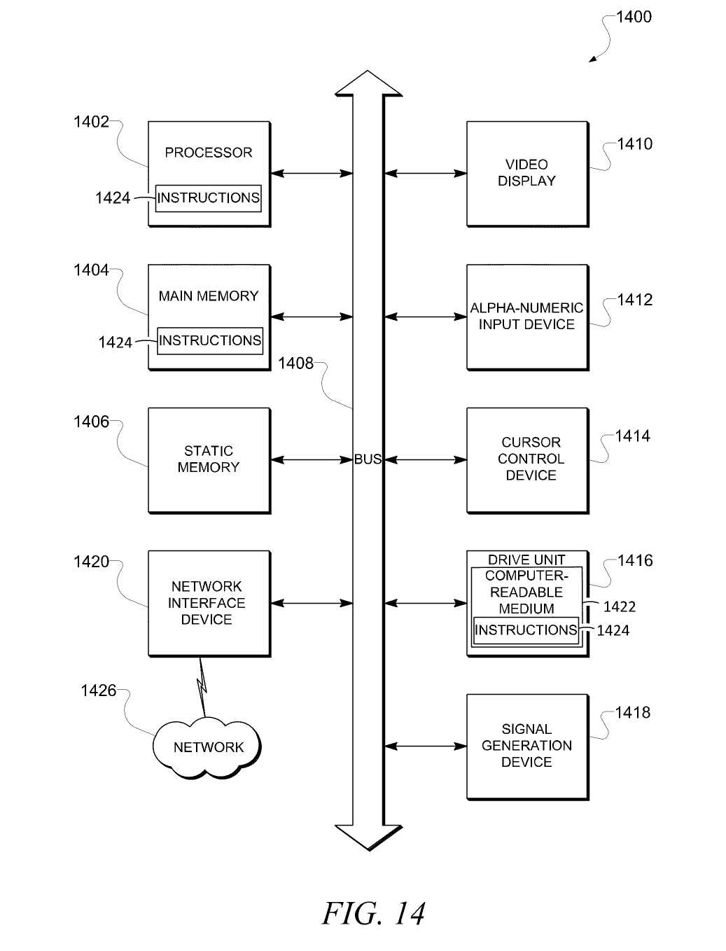

FIG. 14 is a block diagram of machine in the example form of a computer system 1400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard or a touch-sensitive display screen), a user interface (UI) navigation device 1414 (e.g., a mouse), a disk drive unit 1416, a signal generation device 1418 (e.g., a speaker) and a network interface device 1420.

### Machine-Readable Medium

The disk drive unit 1416 includes a machine-readable medium 1422 on which is stored one or more sets of instructions and data structures (e.g., software) 1424 embodying or utilized by any one or more of the methodologies or functions described herein. The instructions 1424 may also reside, completely or at least partially, within the main memory 1404 and/or within the processor 1402 during execution thereof by the computer system 1400, the main memory 1404 and the processor 1402 also constituting machine-readable media.

While the machine-readable medium 1422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1424 may further be transmitted or received over a communications network 1426 using a transmission medium. The instructions 1424 may be transmitted using the network interface device 1420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
displaying, via an administrator user interface, to a user associated with a company, a plurality of content items;
receiving, via the administrator user interface, a user specification of a topic-based group and a user request to broadcast a recommendation to view a specific content item to one or more employees of the company that are members of an online social networking service and that are associated with the topic-based group;
identifying the one or more employees of the company that are associated with the topic-based group; and
broadcasting the recommendation to view the specific content item to the one or more employees of the company that are associated with the topic-based group.

2. The method of claim 1, wherein the receiving of the user request further comprises:
displaying, via the administrator user interface, indicia of multiple topic-based groups; and
receiving, via the administrator user interface, a user selection of a first one of the indicia associated with the topic-based group.

3. The method of claim 1, further comprising associating an employee of the company with the topic-based group by:
displaying, via an employee user interface displayed on a mobile device associated with the employee, a list of topic-based groups;
receiving, via the employee user interface, a user selection of the topic-based group; and
associating the employee with the selected topic-based group.

4. The method of claim 1, wherein the topic-based group is associated with a particular genre or topic.

5. The method of claim 1, further comprising associating an employee of the company with the topic-based group by:
receiving, via the administrator user interface, a user specification of the topic-based group and attribute values for one or more member profile attributes;
identifying a set of employees of the company on the online social networking service that are associated with the user-specified attribute values; and
transmitting a notification to the identified set of employees prompting them to join the topic-based group.

6. The method of claim 5, further comprising:
receiving, via an employee user interface displayed on a device associated with a specific employee of the identified set of employees, a request to join the topic-based group; and
associating the specific employee with the topic-based group.

7. The method of claim 5, wherein the member profile attributes include at least one of age, location, industry, current job, employer, experience, skills, education, school, groups, company, Influencers, endorsements, seniority level, company size, connection count, and connection identities.

8. The method of claim 1, further comprising associating an employee of the company with the topic-based group by:
identifying a set of employees of the company on the online social networking service that have an inferred interest in the topic-based group, based on member profile attributes of the set of employees; and
transmitting a notification to the identified set of employees prompting them to join the topic-based group.

9. The method of claim 8, further comprising:
receiving, via an employee user interface displayed on a device associated with a specific employee of the identified set of employees, a request to join the topic-based group; and
associating the specific employee with the topic-based group.

10. The method of claim 8, wherein the member profile attributes include at least one of age, location, industry, current job, employer, experience, skills, education, school, groups, company, Influencers, endorsements, seniority level, company size, connection count, and connection identities.

11. A system comprising:
a processor; and
a memory device holding an instruction set executable on the processor to cause the system to perform operations comprising:
displaying, via an administrator user interface, to a user associated with a company, a plurality of content items;
receiving, via the administrator user interface, a user specification of a topic-based group and a user request to broadcast a recommendation to view a specific content item to one or more employees of the company that are members of an online social networking service and that are associated with the topic-based group;
identifying the one or more employees of the company that are associated with the topic-based group; and
broadcasting the recommendation to view the specific content item to the one or more employees of the company that are associated with the topic-based group.

12. The system of claim 11, wherein the receiving of the user request further comprises:
displaying, via the administrator user interface, indicia of multiple topic-based groups; and
receiving, via the administrator user interface, a user selection of a first one of the indicia associated with the topic-based group.

13. The system of claim 11, wherein the operations further comprise associating an employee of the company with the topic-based group by:
displaying, via an employee user interface displayed on a mobile device associated with the employee, a list of topic-based groups;
receiving, via the employee user interface, a user selection of the topic-based group; and
associating the employee with the selected topic-based group.

14. The system of claim 11, wherein the operations further comprise associating an employee of the company with the topic-based group by:
receiving, via the administrator user interface, a user specification of the topic-based group and attribute values for one or more member profile attributes;
identifying a set of employees of the company on the online social networking service that are associated with the user-specified attribute values; and
transmitting a notification to the identified set of employees prompting them to join the topic-based group.

15. The system of claim 11, wherein the operations further comprise associating an employee of the company with the topic-based group by:
identifying a set of employees of the company on the online social networking service that have an inferred interest in the topic-based group, based on member profile attributes of the set of employees; and
transmitting a notification to the identified set of employees prompting them to join the topic-based group.

16. A non-transitory machine-readable storage medium comprising instructions that, when executed by one or more processors of a machine, cause the machine to perform operations comprising:
displaying, via an administrator user interface, to a user associated with a company, a plurality of content items;
receiving, via the administrator user interface, a user specification of a topic-based group and a user request to broadcast a recommendation to view a specific content item to one or more employees of the company that are members of an online social networking service and that are associated with the topic-based group;
identifying the one or more employees of the company that are associated with the topic-based group; and
broadcasting the recommendation to view the specific content item to the one or more employees of the company that are associated with the topic-based group.

17. The storage medium of claim 16, wherein the receiving of the user request further comprises:
displaying, via the administrator user interface, indicia of multiple topic-based groups; and
receiving, via the administrator user interface, a user selection of a first one of the indicia associated with the topic-based group.

18. The storage medium of claim 16, wherein the operations further comprise associating an employee of the company with the topic-based group by:
displaying, via an employee user interface displayed on a mobile device associated with the employee, a list of topic-based groups;
receiving, via the employee user interface, a user selection of the topic-based group; and
associating the employee with the selected topic-based group.

19. The storage medium of claim 16, wherein the operations further comprise associating an employee of the company with the topic-based group by:
receiving, via the administrator user interface, a user specification of the topic-based group and attribute values for one or more member profile attributes;
identifying a set of employees of the company on the online social networking service that are associated with the user-specified attribute values; and
transmitting a notification to the identified set of employees prompting them to join the topic-based group.

20. The storage medium of claim 16, wherein the operations further comprise associating an employee of the company with the topic-based group by:
identifying a set of employees of the company on the online social networking service that have an inferred interest in the topic-based group, based on member profile attributes of the set of employees; and
transmitting a notification to the identified set of employees prompting them to join the topic-based group.
